(19) United States
(12) Patent Application Publication
(10) Pub. No.: US 2010/0297364 A1
(43) Pub. Date: Nov. 25, 2010

(54) SERVO PATTERN FORMING METHOD OF HARD DISK DRIVE

(75) Inventors: Yoon Chul CHO, Seoul (KR); Cheol-Soon Kim, Anyang-si (KR); Ha Yong Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/783,803

(22) Filed: May 20, 2010

(30) Foreign Application Priority Data
May 21, 2009 (KR) 2009-0044487

(51) Int. Cl. G11B 5/127

(52) U.S. Cl. 427/599; 118/56

(57) ABSTRACT

A servo pattern forming method of a hard disk drive includes magnetically printing a reference servo pattern, which has different features according to zones divided along a radial direction of a disk, on the disk, and recording a final servo pattern in the disk on the basis of the reference servo pattern. As a result, the quality of a final servo pattern can be enhanced by preventing an amplitude drop that arises in an ID zone of the disk when a reference servo pattern is recorded using a conventional servo track writer.

### CROSS-REFERENCE TO RELATED APPLICATIONS

This application claims priority under 35 U.S.C. §119 from Korean Patent Application No. 10-2009-0044487, filed on May 21, 2009, in the Korean Intellectual Property Office, the disclosure of which is incorporated herein by reference.

### BACKGROUND

1. Field of the General Inventive Concept

The present general inventive concept relates to a servo pattern forming method of a hard disk drive, and more particularly, to a servo pattern forming method using a magnetic printing method

2. Description of the Related Art

A hard disk drive (HDD) is a data storage device which can convert a digital electronic pulse containing data into a permanent magnetic field and write it or read the data written in the disk. Such a hard disk drive is advantageous to write and read massive data at high speed, and thus has been utilized as a representative auxiliary memory device of a computer system.

Meanwhile, a normal operation of reading and writing data in the hard disk drive begins from reading a servo pattern recorded in a servo track of the disk and going to a correct location.

An operation of recording the servo pattern on the servo track is called servo track writing (STW), and there is an ammonite servo track writing (ASTW) method as a representative STW. The ASTW method is a method of recording the servo pattern in two stages, which first records a reference servo pattern on the servo track of the disk using a servo track writer and records a final servo pattern in the disk on the basis of the reference servo pattern.

At this time, the reference servo pattern is recorded as a basic unit of several tracks, and the final servo pattern is recorded in detail on each track while performing a servo control based on the reference servo pattern. Generally, the reference servo pattern is recorded inside a clean room, but the final servo pattern is recorded outside the clean room.

FIG. 1 is a view illustrating a feature of a spiral reference servo pattern recorded in the disk by a conventional servo track writer. Specifically, a part of the reference servo pattern in an inner diameter (ID) zone of the disk 1 and a part of the reference servo pattern in an outer diameter (OD) zone of the disk 1 are enlarged in FIG. 1.

Referring to FIG. 1, a track width TW₁ of the reference servo pattern in the ID zone of the disk 1 is equal to a track width TW₂ of the reference servo pattern in the OD zone of the disk 1, while a bit length BL₁ of the reference servo pattern in the ID zone of the disk 1 is shorter than a bit length BL₂ of the reference servo pattern in the OD zone of the disk 1. The reason why the reference servo pattern has such a feature is because the reference servo pattern is recorded with one frequency by a magnetic head 11 provided in the servo track writer 10 and the circumference of the disk 1 becomes smaller as going from the edge to the center.

However, since the amplitude of the reference servo pattern is proportional to a product between the bit length and the track width of the reference servo pattern, an amplitude drop of the reference servo pattern arises in the ID zone when the conventional servo track writer is used in recording the reference servo pattern. Such an amplitude drop of the reference servo pattern in the ID zone results in deteriorating the quality of the final servo pattern recorded on the basis of the reference servo pattern.

### SUMMARY

The present general inventive concept provides a servo pattern forming method of a hard disk drive, which can enhance quality of a final servo pattern by preventing an amplitude drop in an inner diameter (ID) zone of the disk and improve productivity and reduce costs by shortening time of a process performed in a clean room as compared with the method of recording the reference servo pattern using the conventional servo track writer.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by magnetically printing a reference servo pattern, which has different features according to zones divided along a radial direction of a disk, on the disk, and recording a final servo pattern in the disk on the basis of the reference servo pattern.

The feature of the reference servo pattern may include at least one of a bit length and a track width of the reference servo pattern.

The reference servo pattern may have a feature that a bit length increases as going from an edge to a center of the disk. The reference servo pattern may include the bit lengths which are different from one another according to zones of the disk.

The reference servo pattern may have a feature that a track width increases as going from an edge to a center of the disk. The reference servo pattern may include the track widths which are different from one another according to zones of the disk.

The reference servo pattern may have a feature that a bit length and a track width increase as going from an edge to a center of the disk.

The reference servo pattern may be provided to have a spiral pattern.

The magnetically printing the reference servo pattern may include preparing a master disk formed with a magnetic substance pattern to correspond to the reference servo pattern, applying a first magnetic field to the disk to initially magnetize the disk, aligning a center of the disk with a center of the master disk and making the disk and the master disk come into contact with each other, and applying a second magnetic field opposed to the first magnetic field to the master disk.

Each of the first magnetic field and the second magnetic field may be in parallel with or perpendicular to a surface of the disk.

The features of the reference servo pattern may further include a plurality of sub-patterns and demarcation patterns, wherein distances between the sub-patterns and demarcation patterns of a portion of the servo pattern may be adjusted to alter an amplitude of the portion of the servo pattern.

The foregoing and/or other aspects and utilities of the present general inventive concept may also be achieved by forming a plurality of magnetic substance patterns on a master disk, applying a first magnetic field to a second disk to form a second magnetic field in the hard disk, attaching the master disk to the hard disk, and applying a third magnetic field to the second disk to vary the direction of the second magnetic filed in the second disk to form a reference servo pattern within the hard drive, and recording a final servo pattern in the disk on the basis of the reference servo pattern

The plurality of magnetic substance patterns may include a plurality of concave and convex portions formed on the master disk.

The plurality of magnetic substance patterns may include first concave portions of a first length and second concave portions of a second length different from the first length.

The foregoing and/or other aspects and utilities of the present general inventive concept may also be achieved by forming first and second reference servo patterns on a hard disk, the first and second reference servo patterns, being formed in at least an inner diameter and an outer diameter of the hard disk to have substantially the same amplitudes as each other.

The first reference servo pattern formed in an inner diameter may have a larger bit length than a bit length of the second reference servo pattern formed in an outer diameter of the hard disk.

The first reference servo pattern formed in an inner diameter may have a larger track width than the track width than a track width of the second reference servo pattern formed in an outer diameter of the hard disk.

The foregoing and/or other aspects and utilities of the present general inventive concept may also be achieved by providing a servo pattern forming system including a master disk having a plurality of magnetic substance patterns formed thereon, the magnetic substance patterns comprising convex and concave portions of varying dimensions, a hard disk to be attached and detached from the master disk, and a magnet to be positioned close to the hard disk to apply a plurality of magnetic fields in different directions to the hard disk.

The plurality of magnetic fields may be applied with uniform magnetization.

The plurality of magnetic substance patterns may further include a reference servo pattern having an inner diameter (ID) zone and an outer diameter (OD) zone, the servo patterns in the ID zone and the OD zone having different respective dimensions and having substantially the same amplitude.

The plurality of magnetic substance patterns may further include a reference servo pattern having an inner diameter (ID) zone and an outer diameter (OD) zone, the ID zone having a plurality of sub-patterns and demarcation patterns, wherein the distances between the sub-patterns and demarcation patterns of the ID zone may be adjusted to alter the amplitude of the servo pattern of the ID zone.

### BRIEF DESCRIPTION OF THE DRAWINGS

Exemplary embodiments of the present general inventive concept will be more clearly understood from the following detailed description taken in conjunction with the accompanying drawings in which:

The above and/or other features and utilities of the present general inventive concept will become apparent and more readily appreciated from the following description of the exemplary embodiments, taken in conjunction with the accompanying drawings, in which:

FIG. 1 is a view illustrating a feature of a spiral reference servo pattern recorded in a hard disk drive by a conventional servo track writer;

FIG. 2 is a perspective view illustrating a hard disk drive to which the servo pattern forming method of the hard disk drive according to the present general inventive concept;

FIG. 3 is a schematic block diagram illustrating a driving circuit for the hard disk drive of FIG. 2;

FIG. 4 is a view illustrating a feature of the spiral reference servo pattern, which is magnetically printed in the disk, in the servo pattern forming method of the hard disk drive according to an exemplary embodiment of the present general inventive concept;

FIGS. 5A to 5G are views illustrating a process of forming the spiral reference servo pattern of FIG. 4 through a magnetic printing method; and

FIG. 6 is a view illustrating a feature of a spiral reference servo pattern, which is magnetically printed in a disk, in a servo pattern forming method according to another exemplary embodiment of the present general inventive concept.

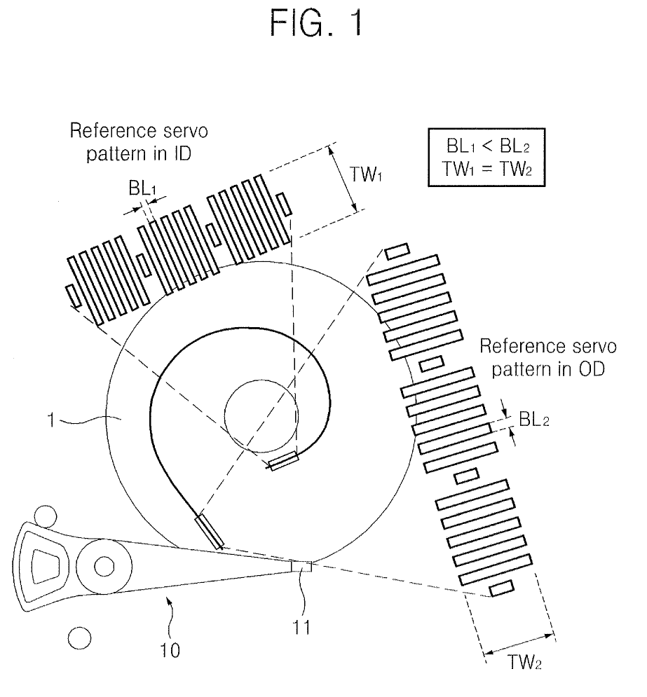

### DETAILED DESCRIPTION OF THE EMBODIMENTS

The attached drawings illustrate embodiments of the general inventive concept are referred to in order to gain a sufficient understanding of the general inventive concept and the merits thereof. Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, the general inventive concept will be described in detail by explaining embodiments of the general inventive concept with reference to the attached drawings. Also, descriptions of publicly-known functions or configurations will be omitted for clarity.

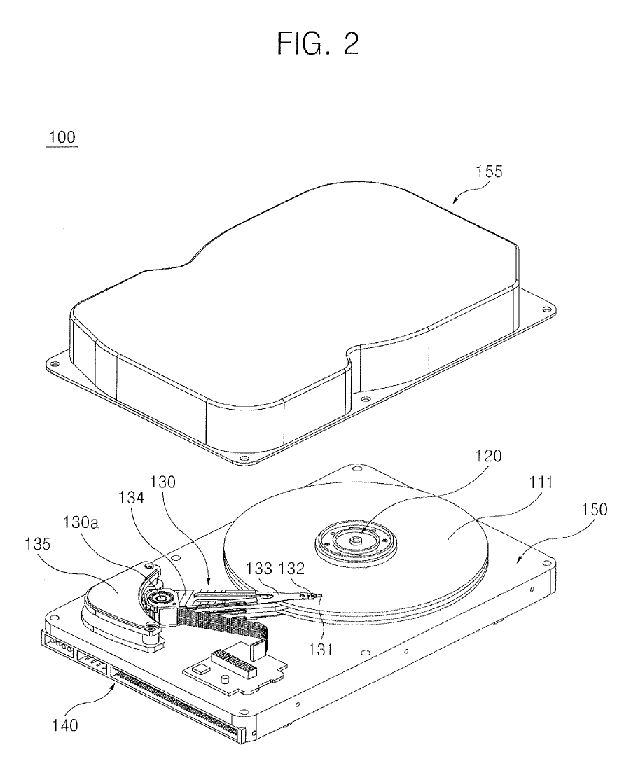

FIG. 2 is a perspective view illustrating a hard disk drive to which the servo pattern forming method of the hard disk drive according to the present general inventive concept is applied.

Referring to FIG. 2, a hard disk drive 100 includes at least one disk 111 in which data is recorded, a spindle motor 120 to rotate the disk 111, a head stack assembly (HSA) 130 writing data on the disk 111 or reading the data from the disk 111 while moving on the disk 111 with respect to a pivot shaft 130a, a printed circuit board assembly (PCBA) 140 having a printed circuit board (PCB) mounted with most of circuit parts thereon and electrically controlling the hard disk drive 100, a base 150 in which these elements are assembled, and a cover 155 covering the base 150.

As illustrated in FIG. 2, two disks 111 are stacked up and down on the spindle motor 120. At this time, the two disks 111 are fitted to and rotatably supported by a hub of the spindle motor 120 while being spaced from each other by a ring-shaped spacer (not illustrated). Alternatively, one disk 111 may be provided in the hard disk drive, or three or more disks 111 may be provided to record more data to accommodate elements or units of the hard disk drive 100 therein.

The disk 111 is divided into an inner diameter (ID) zone, a middle diameter (MD) zone and an outer diameter (OD) zone in order of distance from the center of the disk 111. Each zone includes a plurality of concentric annular tracks with respect to the center of the disk 111. The ID, MD and OD may have zones having equal number of tracks each, or each zone may have a different number of tracks than another zone. It is possible that the ID, MD and OD can be divided by an equal distance from the center of the disk 111. However, the present general inventive concept is not limited thereto. The number of tracks or the distances from the center of the disk 111 may vary. Each track includes sectors as unit objects divided at equiangular intervals with respect to the center of the disk 111.

The sector may include a servo sector formed with a servo pattern for a servo control such as track-searching and track-following control or the like, and a data sector to record user data. The servo sector and the data sector may be alternately located on the track.

The HSA 130 includes a magnetic head 131 to write or read data on the disk 111, a slider 132 mounted with the magnetic head 131 and lifting up the magnetic head 131 on the disk 111, a suspension 133 elastically supporting the slider 132 toward a surface of the disk 111, an actuator arm 134 supporting the suspension 133 and rotatably coupled to the pivot shaft 130a so that the magnetic head 131 can approach a requested location on the disk 111, and a voice coil motor (VCM) 135 used as an actuator to drive the actuator arm 134 to rotate.

The magnetic head 131 magnetizes the surface of the disk 111 to write data on the disk 111, or senses a magnetic field on the disk 111 to read the data from the disk 111. Substantially, the magnetic head 131 may include a writing head to magnetize the disk 111 and a reading head to sense the magnetic field of the disk 111, but they are not distinguished in the accompanying drawings.

In general, two magnetic heads 131 are provided for one disk 111. The two magnetic heads 131 are arranged as levitating or floating at a predetermined distance from both sides (top and bottom) of the disk 111, respectively. In this embodiment, two disks 111 are provided, so that four magnetic heads 131 are arranged as levitating from both sides of the disks 111, respectively.

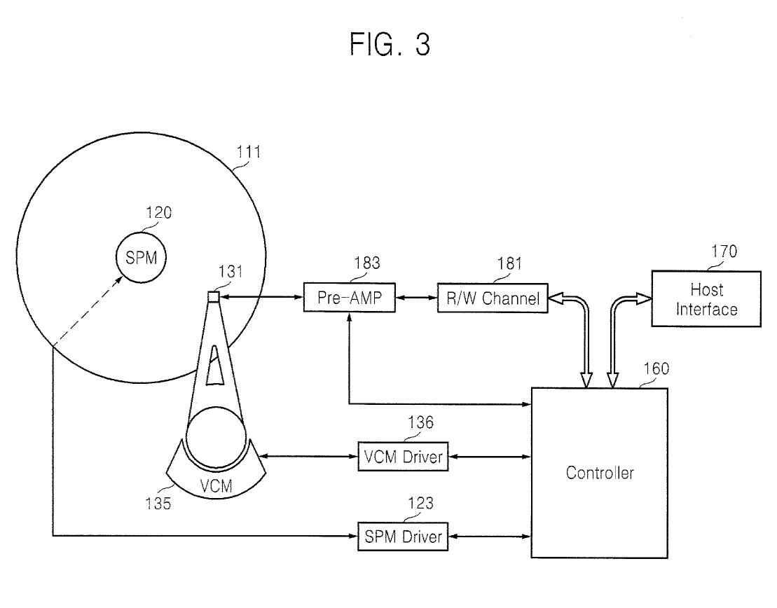

FIG. 3 is a schematic block diagram illustrating a driving circuit for the hard disk drive of FIG. 2.

Referring to FIG. 3, the controller 160 controls a pre-amplifier 183, a read/write channel 181, a host interface 170, a VCM driver 136, a spindle motor (SPM) driver 123, and other components of the hard disk drive 100 such as magnetic heads 131, spindle motor 120 and disk 111.

The pre-amplifier (Pre-AMP) 183 may amplify data signals read from the disk 111 by the magnetic head 131, or amplify a recording electric-current converted through the read/write channel 181 to be written on the disk 111 by the magnetic head 131.

The read/write channel (R/W channel) 181 may convert the signal amplified by the pre-amplifier 183 into a digital signal and transmit it to a host device (not illustrated) via the host interface 170, or receive user input data via the host interface 170, convert the data into a binary data stream easy to write, and inputs the binary data stream to the pre-amplifier 183.

The host interface 170 may transmit the data converted into a digital signal from the read/write channel 181 to the host device, or receives a user's input data from the host device and inputs it to the read/write channel 181 via the controller 160. Here, a host device is a generic term for elements that control and operate a computer system including the hard disk drive. Such elements may include a central processing unit (CPU) and an input/output (I/O) controller 160 of a computer system.

The VCM driver 136 receives a control signal from the controller 160 and adjusts the amount of electric current applied to the voice coil motor 135. The SPM driver 123 receives a control signal from the controller 160 and adjusts the amount of electric current applied to the spindle motor 120.

The controller 160 may receive data input by a user through the host device, from the host interface 170 and output the data to the read/write channel 181 in a data writing mode. The controller 160 may also receive a read signal, converted into a digital signal by the read/write channel 181, and output the read signal to the host interface 170 in a data reading mode. Also, the controller 160 may control the output signals received from the VCM driver 136 and the SPM driver 123.

In a manufacturing process of the present general inventive concept including the hard disk drive 100, the controller 160 may perform a servo copying function that records a final servo pattern in the disk 111 on the basis of a reference servo pattern formed in the disk 111 by a magnetic printing method. In this regard, the magnetic printing method will be described in detail together with the servo pattern forming method of the hard disk drive according to this embodiment.

The controller 160 may be a microprocessor, a microcontroller or the like, and may be achieved in the form of software or firmware. [computer-readable]

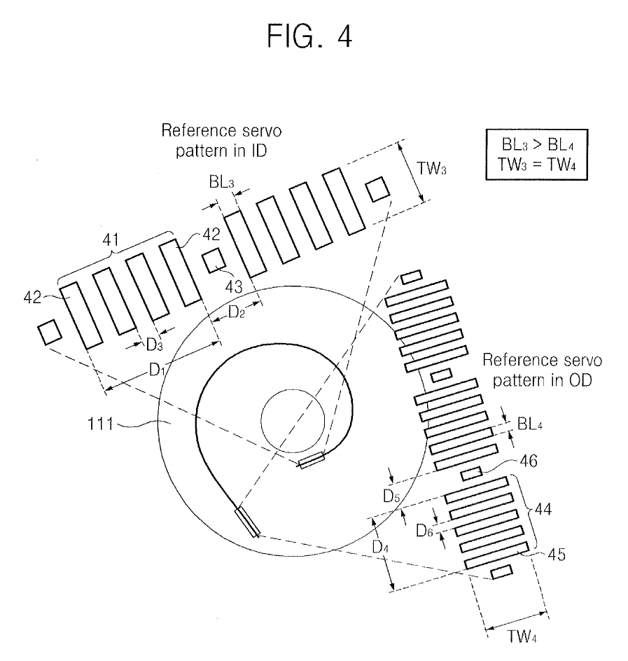

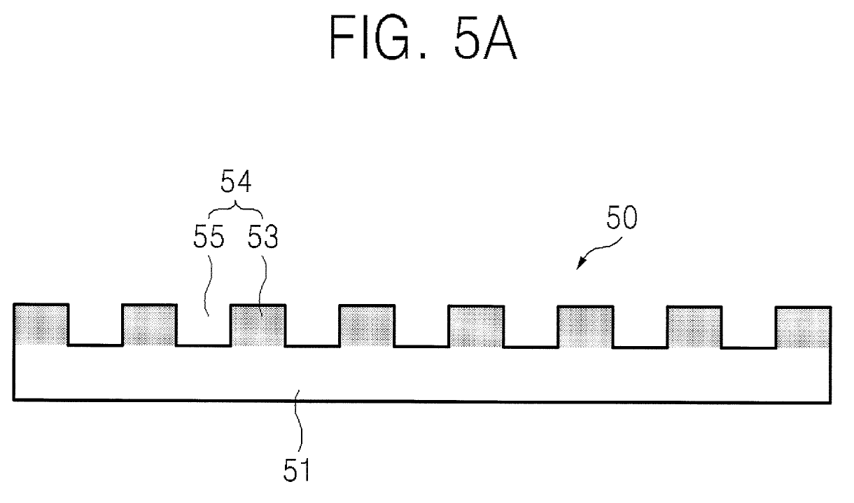

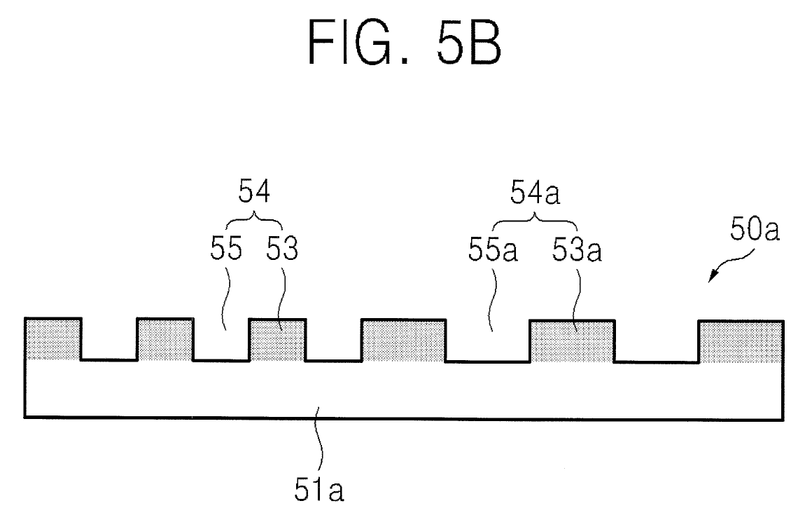

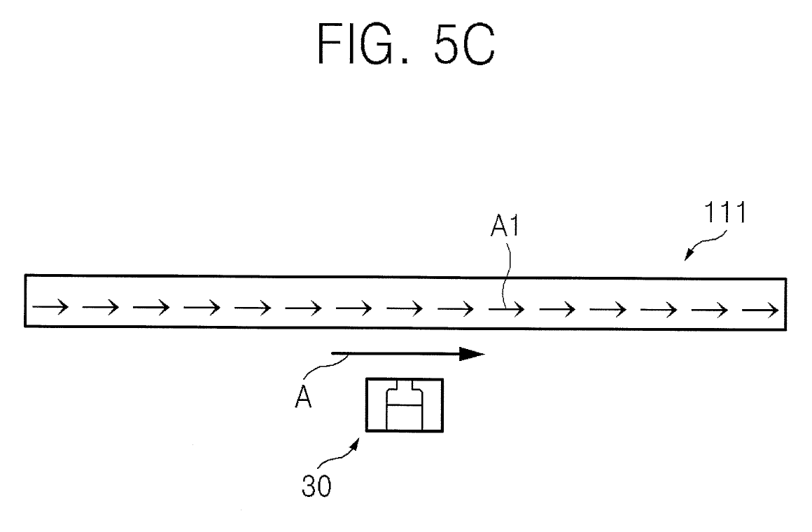

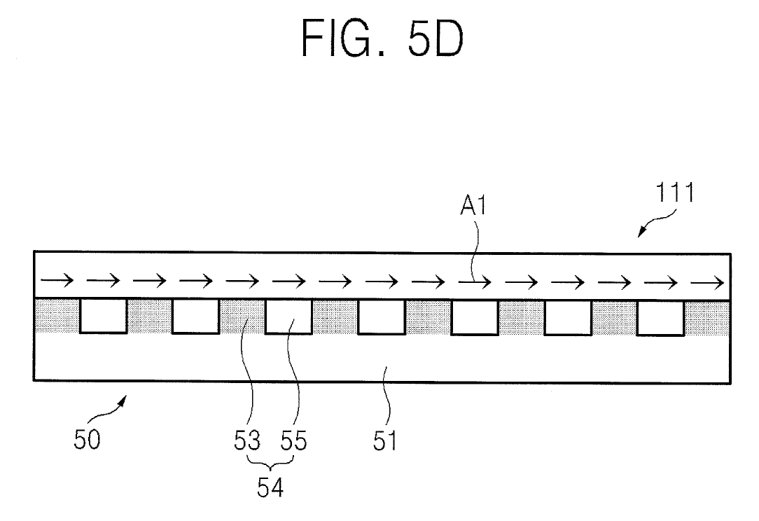

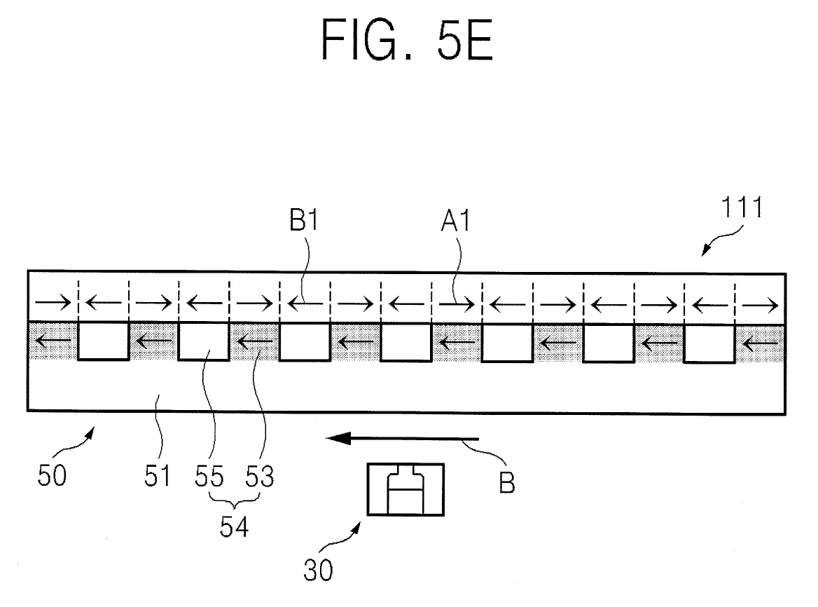

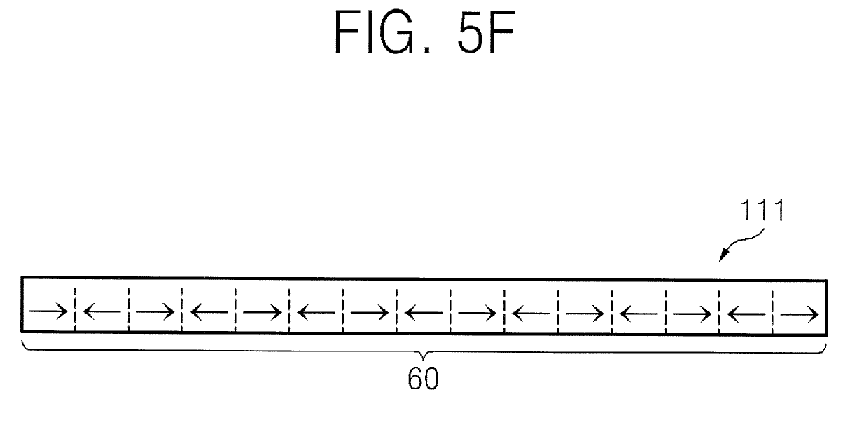

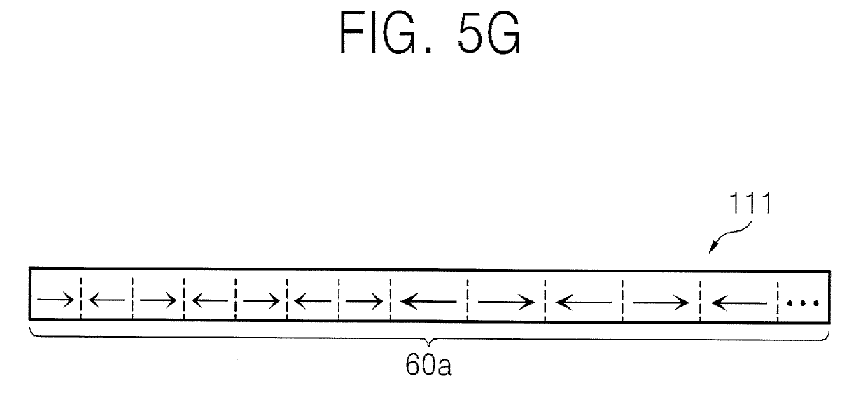

The servo pattern forming method of the hard disk drive according to an exemplary embodiment of the present general inventive concept will be described with reference to FIGS. 4 and 5A to 5G.

FIG. 4 is a view illustrating a feature of a spiral reference servo pattern, which may be magnetically printed in the disk 111, using the servo pattern forming method of a hard disk drive according to an exemplary embodiment of the present general inventive concept, and FIGS. 5A to 5G are views illustrating a process of forming the spiral reference servo pattern of FIG. 4 through a magnetic printing method.

Referring to FIGS. 4 and 5A to 5G, the servo pattern forming method of the hard disk drive in this example embodiment includes magnetic printing of the reference servo pattern, which has different features within the entire pattern on the disk 111 according to zones divided along the radial direction of the disk 111. The servo pattern forming method also includes recording the final servo pattern in the disk 111 on the basis of the reference servo pattern magnetically printed on the disk 111.

The stage of magnetically printing the reference servo pattern on the disk 111 may be performed inside a clean room, and the stage of recording the final servo pattern within the disk 111 on the basis of the reference servo pattern is performed outside the clean room.

In this example embodiment, the zones divided along the radial direction of the disk 111 may be selected as zones of the disk 111, and a feature of the reference servo pattern may be selected to be a bit length of the reference servo pattern. In other words, the reference servo pattern may be formed in the disk 111 so that the bit lengths can be of varying dimensions according to the zones of the disk 111.

Here, the zone of the disk 111 refers to a group of adjacent tracks concentrically located on the disk 111. In general, a zone mapping process is pre-formed to divide the surface of the disk 111 into a plurality of zones before performing a read channel optimizing process. The number of zones on the disk 111 may be determined in consideration of the size of the disk 111 including a track per inch (TPI) factor that indicates the density of tracks, etc. In this example embodiment, one disk 111 may be mapped into 24 zones, though smaller and larger amounts of zones may also be designated.

As opposed to this embodiment, alternatively, the zones divided along the radial direction of the disk 111 may be most broadly selected as three zones of the ID zone, the MD zone and the OD zone, or may be most narrowly selected as the respective tracks.

Referring to FIG. 4, the reference servo pattern is generally provided in the form of a spiral pattern, and the bit length thereof becomes longer as going from the edge to the center of the disk 111. When the reference servo pattern has the shape of a spiral as illustrated, the various zones may be grouped by track length increments.

A part of the reference servo pattern in the OD zone of the disk 111, and a part of the reference servo pattern in the ID zone of the disk 111 are enlarged in FIG. 4. As illustrated therein, a track width TW₃ of the reference servo pattern in the ID zone of the disk 111 is equal to a track width TW₄ of the reference servo pattern in the OD zone of the disk 111, while a bit length BL₃ of the reference servo pattern in the ID zone of the disk 111 is longer than a bit length BL₄ of the reference servo pattern in the OD zone of the disk 111.

The amplitude of the ID zone is proportional to the product between the bit length and the track width in the ID zone. Similarly, the amplitude of the OD zone is proportional to the product between the bit length and the track width within the OD zone. Depending on whether one or both of a bit length or track width is to be varied when forming a reference servo pattern in each zone, the amplitude of the ID zone may be formed to have relatively the same amplitude of the reference servo pattern in the OD zone to eliminate an amplitude drop in the disk 111 and provide greater stability and longevity to the total reference servo pattern.

Thus, the reference servo pattern, of which the bit length may increase going from an outer edge of the disk 111 to the center of the disk 111, may be formed in the disk 111 by the magnetic printing method to be described below since it cannot be substantially achieved by a recording method of a conventional servo track writer. Here, the magnetic printing method may also be called a contact magnetic transfer (CMT), and refers to a method that instantly records a magnetic pattern on a magnetic medium throughout a broad zone. Below, the stage of magnetically printing the reference servo pattern on the disk 111 will be described in detail with reference to FIGS. 5A to 5G.

As illustrated in FIG. 4, the reference servo patterns may be broken down into groupings and sub-patterns to represent various types of data and to provide demarcation points within a servo pattern. Within the servo patterns, not only may the distance of the bit length and the track width be manipulated to ensure balanced amplitude between a servo pattern in an ID zone and an OD zone, but the length D₁ of a bit grouping 41, the distance D₂ between bit groupings 41, and the length D₃ between sub-patterns 42 may be increased or decreased to provide proper balance between the amplitudes of the various zones. The distance D₂ between bit groupings 41 may include a demarcation sub-pattern 43. In this manner, instead of the bit length BL₃ of the reference servo pattern in the ID zone being increased as previously described, the space D₃ between the bit lines or the distance D₂ between bit line groupings 41 may be increased and the bit length BL₃ kept at a smaller length than the distance D₃ to achieve a same servo pattern length within the ID zone as previously described.

Similarly, the length of the reference servo pattern in the OD may also be altered by varying the distance D₄ of a bit grouping 44, the distance D₅ between bit groupings 44, and the length D₆ between sub-patterns 45 to achieve balance in amplitude between the various zones of the reference servo pattern.

As illustrated in FIG. 5A, there may be performed a stage of preparing at least one master disk 50 formed with a magnetic substance pattern 54 to correspond to the reference servo pattern to be printed on the disk 111. Specifically, a magnetic substance, for example, Ni, Fe and/or Co alloy is stacked on a disk-shaped silicon substrate 51 having a flat surface by a sputtering or deposition method, and undergoes lithography or the like method to form the magnetic substance pattern 54, to correspond to the reference servo pattern (in this example embodiment in which the bit length increases going from the outer edge of the disk 111 to the center of the disk 111) to be printed on the disk 111, on the silicon substrate 51, thereby preparing the master disk 50. However, the method of forming the magnetic substance pattern 54 of the master disk 50 is not limited to the foregoing descriptions, but may be selected variously. The magnetic substance pattern 54 of the master disk 50 may include a convex portion 53 and a concave portion 55. For reference, the master disk 50 may be also called a ‘master template’ or a ‘transfer master’.

Though not illustrated, a method of forming reference servo patterns of the present general inventive concept may also include forming additional master disks to correspond to reference servo patterns with varying bit lengths and track widths. In the method of forming a plurality of zones including an ID zone and an OD zone, a first master disk may be replaced with a second master disk at the end of the pre-determined track length of one zone and the beginning of a track length of another zone. In this way, reference servo patterns of varying bit lengths and track widths may be formed on a single and a plurality of disks.

Also, as illustrated in FIG. 5B, instead of using a plurality of master disks with varying bit lengths and track widths, a single master disk 50a with a single track width and varying bit lengths may be used to form a desired reference servo pattern. Alternatively, though not illustrated, a master disk having varying track widths and a single bit length may also be used to form a desired reference servo pattern.

As illustrated in FIG. 5B, there may be performed a stage of preparing at least one master disk 51a formed with a magnetic substance pattern 54 as illustrated in FIG. 5A to correspond to the reference servo pattern to be printed within the OD zone of the disk 111. A magnetic substance pattern 54a may be formed on the surface of a substrate 51a to correspond to a reference servo pattern to be printed within the ID zone of the disk 111. The magnetic substance pattern 54a of the master disk 50a may include a convex portion 53 and a concave portion 55 of a first length and a convex portion 53a and a concave portion 55a of a second length longer than the first length.

As illustrated in FIG. 5C, there is performed a stage of initially magnetizing the disk 111. Specifically, a magnet 30 may be positioned close to the disk 111 so that a first magnetic field A can be applied to the disk 111, thereby magnetizing a magnetic layer of the disk 111 in one direction A1. For uniform magnetization, the disk 111 may move with respect to a fixed magnet 30 or the magnet 30 may move with respect to a fixed disk 111.

As illustrated in FIG. 5D, there is performed a stage of aligning the center of the disk 111 magnetized in one direction A1 with the center of the master disk 50 formed with the magnetic substance pattern 54 and making the disk 111 and the master disk 50 come into contact with each other. At this time, for the stable contact, the master disk 50 may be pressed to the disk 111.

As illustrated in FIG. 5E, in the state that the disk 111 and the master disk 50 are in contact with each other, there is performed a stage of positioning the magnet 30 close to the master disk 50 and applying a second magnetic field B opposed to the first magnetic field A, applied in the above stage of initially magnetizing the disk 111 through the magnet 30. At this time, since the convex portion 55 of the magnetic substance pattern 54 is magnetized in the same direction B1 as the second magnetic field B, a part of the disk 111 being in contact with the concave portion 53 of the magnetic substance pattern 54 is maintained in the direction A1 of the initial magnetization, but a part of the disk 111 not in contact with the magnetic substance pattern 54 (i.e., a part of the disk 111 located on the convex portion 55 of the magnetic substance pattern 54) is magnetized in the same direction B1 as the second magnetic field B.

As illustrated in FIGS. 5E and 5F, the master disk 50 is separated from the disk 111, so that the reference servo pattern 60 to correspond to the magnetic substance pattern 54 of the master disk 50 can be formed in the disk 111. Also, as illustrated in FIG. 5G, similar processes described with reference to FIGS. 5C to 5E may be performed in order that the master disk 50a illustrated in FIG. 5B may be separated from the disk 111. In this way, the reference servo pattern 60a with varying lengths to correspond to the magnetic substance pattern 54 and 54a of the master disk 50a can also be formed in the disk 111.

Though not illustrated, to produce the varying lengths of the sub-patterns 43, 46 and the spaces D₂, D₅ and other dimensions illustrated in FIG. 4, the fabrication of the concave and convex portions and formation of the magnetic substance patterns illustrated in FIGS. 5A-5G may be adjusted to achieve desired lengths and widths described herein.

In this embodiment, the magnetic printing method forming a so-called horizontal magnetic field is used to form the reference servo pattern on the disk 111, but is not limited thereto. Alternatively, a magnetic printing method forming a so-called vertical magnetic field may be used to form the reference servo pattern required in the present general inventive concept on the disk 111.

The horizontal and vertical magnetic fields are referred to as “so-called” because, as is known in the art, horizontal and vertical vantage points are relative. A substrate or disk may be manufactured and operated in any number of vertical, horizontal, diagonal and inverted positions within the x, y and z planes. Also, magnetic fields rarely are two dimensional, and also extend in x, y and z directions.

If the stages of magnetically printing the reference servo pattern on the disk 111 are completed, a stage of recording the final servo pattern in the disk 111 on the basis of the reference servo pattern may be performed. Specifically, the final servo pattern may be recorded by the magnetic head 131 provided in the hard disk drive 100 in a state that the disk 111 formed with at least one of the reference servo patterns is assembled within the hard disk drive 100. The stage of recording the final servo pattern is controlled by the controller 160 provided in the hard disk drive 100 (see FIGS. 2 and 3).

As described above, in the servo pattern forming method of the hard disk drive according to this exemplary embodiment, the reference servo pattern, of which the bit length may increase going from an outer edge of the disk 111 to the center of the disk 111, is formed in the disk 111 by the magnetic printing method, thereby solving a problem that the quality of the final servo pattern is deteriorated due to an amplitude drop of the reference servo pattern in the ID zone when the reference servo pattern is recorded in the disk by a conventional servo track writer.

In the case of using the conventional servo track writer to record the reference servo patter in the disk 111, because the reference servo pattern is recoded with one frequency by the magnetic head provided in the servo track writer but the circumference of the disk 111 becomes smaller as going from the edge to the center of the disk 111, the bit length of the reference servo patter in the ID zone is formed smaller than that in the OD zone. Meanwhile, since the amplitude of the reference servo pattern is proportional to a product between the bit length and the track width of the reference servo pattern, the amplitude drop of the reference servo pattern arises in the ID zone when the conventional servo track writer is used in recording the reference servo pattern in the disk 111. Such an amplitude drop of the reference servo pattern in the ID zone results in deteriorating the quality of the final servo pattern recorded on the basis of the reference servo pattern.

On the contrary, according to the servo pattern forming method of the hard disk drive in an example embodiment, a magnetic printing method is employed in forming the reference servo patterns of increasing width towards the center and the bit length of the reference servo pattern increases as going from an outer edge of the disk 111 to the center of the disk 111, so that the amplitude drop of the reference servo pattern in the ID zone can be prevented, thereby enhancing the quality of the final servo pattern.

Further, the servo pattern forming method of the hard disk drive in this embodiment employs the magnetic printing method in forming the reference servo patterns, so that time of a process performed in the clean room can be shortened as compared with the conventional method of using the servo track writer to record the reference servo pattern, thereby improving productivity and reducing costs of using the clean room.

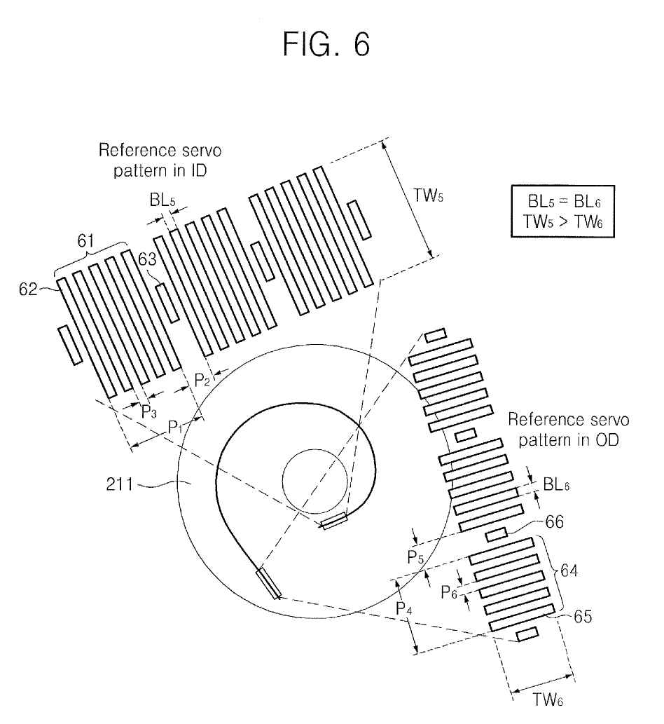

FIG. 6 is a view illustrating a feature of a spiral reference servo pattern, which is magnetically printed in a disk, in a servo pattern forming method according to another exemplary embodiment of the present general inventive concept. Referring to FIG. 6, the servo pattern forming method according to another exemplary embodiment of the present general inventive concept will be described by laying emphasis on differences from the foregoing embodiments.

Like the foregoing embodiments, the servo pattern forming method of the hard disk drive in this example embodiment includes magnetically printing the reference servo pattern, which may have different features from each other according to zones divided along the radial direction of the disk 211, and recording the final servo pattern in the disk 211 on the basis of the reference servo pattern magnetically printed on the disk 211. Similarly to the above mentioned embodiment, the zones divided along the radial direction of the disk 211 may be selected as zones of the disk 211.

The feature of the reference servo pattern in this example embodiment is selected to have a variable track width of a reference servo pattern. In other words, the reference servo pattern may be formed on the disk 211 so that track widths of the reference servo pattern can be different from one another according to zones of the disk 211.

By varying the track width of the ID zone instead of the bit length as described in a previous example embodiment, the amplitude of the reference servo pattern that is proportional to a product between the bit length and the track width of the reference servo pattern will not suffer an amplitude drop of the reference servo pattern as is the case in conventions reference servo patters.

Referring to FIG. 6, the reference servo pattern is generally provided in the form of a spiral pattern, and the track width thereof may become longer as going from an outer edge of the disk 211 to the center of the disk 211.

Similar to the plurality of master disks described in a previously described example embodiment, a plurality of master disks may be used in the present example embodiment to produce track widths of varying lengths to correspond to an ID zone, an MD zone and an OD zone. Also, instead of a plurality of master disks, a single master disk with the same bit lengths and varying track widths may be used.

A part of the reference servo pattern in the ID zone of the disk 211, and a part of the reference servo pattern in the OD zone of the disk 211 are enlarged in FIG. 6. As illustrated, a bit length BL₅ of the reference servo pattern in the ID zone of the disk 211 may be equal to a bit length BL₆ of the reference servo pattern in the OD zone of the disk 211, while a track width TW₅ of the reference servo pattern in the ID zone of the disk 211 may be larger than a track width TW₆ of the reference servo pattern in the OD zone of the disk 211.

As illustrated in FIG. 6, the reference servo patterns may be broken down into groupings and sub-patterns to represent various types of data and to provide demarcation points within a servo pattern. Within the servo patterns, not only may the distance of the bit length and the track width be manipulated to ensure balanced amplitude between a servo pattern in an ID zone and an OD zone, but the length P₁ of a bit grouping 61, the distance P₂ between bit groupings 61, and the length P₃ between sub-patterns 62 may be increased or decreased to provide proper balance between the amplitudes of the various zones. The distance P₂ between bit groupings 61 may include a demarcation sub-pattern 63. In this manner, instead of the track width TW₅ of the reference servo pattern in the ID zone being increased as previously described, the space P₃ between the bit lines or the distance P₂ between bit line groupings 61 may be increased and the bit length TW₅ kept at a narrower width to achieve a same servo pattern width within the ID zone as previously described. Also, to increase or decrease the length of the reference servo pattern in the ID zone as illustrated in FIG. 6, the track width TW₅ may be increased or decreased. Alternatively or concurrently, any of the lengths P₁, P₂ or P₃ may be increased or decreased to balance the amplitude of the ID zone with that of the OD zone.

Similarly, the length of the reference servo pattern in the OD may also be altered by varying the distance P₄ of a bit grouping 64, the distance P₅ between bit groupings 64, and the length P₆ between sub-patterns 65 to achieve balance in amplitude between the various zones of the reference servo pattern.

Though not illustrated, to produce the varying lengths of the sub-patterns 63, 66 and the spaces P₂, P₅ and other dimensions illustrated in FIG. 6, the fabrication of the concave and convex portions and formation of the magnetic substance patterns illustrated in FIGS. 5A-5G may be adjusted to achieve desired lengths and widths described herein.

The servo pattern forming method of the hard disk drive in this example embodiment is substantially the same as the foregoing embodiments except that the track width of the reference servo pattern formed in the disk 211 may become larger going from an outer edge of the disk 211 to the center of the disk 211, and thus repetitive descriptions thereof will be avoided as necessary.

As described above, according to the servo pattern forming method of the hard disk drive in this example embodiment, the magnetic printing method may be employed in forming the reference servo pattern and the track width of the reference servo pattern may be increased going from an outer edge of the disk 211 to the center of the disk 211, so that the amplitude drop of the reference servo pattern in the ID zone can be prevented by the same reasons described in the foregoing embodiments, thereby enhancing the quality of the final servo pattern.

As described above, in a method of forming a servo pattern in a hard disk drive, a reference servo pattern varied in a feature depending on zones divided along a radial direction of the disk is formed by a magnetic printing method, so that quality of a final servo pattern can be enhanced by preventing an amplitude drop that arises in an ID zone of the disk when a reference servo pattern is recorded using a conventional servo track writer, and productivity can be improved and costs can be reduced by shortening time of a process performed in a clean room as compared with the method of using the conventional servo track writer to record the reference servo pattern.

While the general inventive concept has been particularly illustrated and described with reference to exemplary embodiments thereof, it will be understood that various changes in form and details may be made therein without departing from the spirit and scope of the following claims.

For example, in the above described embodiments, a reference servo pattern may be formed in the disks 111 and 211 to have the features of increasing the bit length or the track width as going from an outer edge of the disks to the center of the disks 111 and 211, but not limited thereto. Alternatively, the reference servo pattern may be formed in the disks 111 and 211 to have features of increasing both the bit length and the track width as going from the edge to the center of the disks 111 and 211. The manufacturing processes of forming disks with servo patterns of increased bit length and track width may be formed by the processes as described herein.

Although a few embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A servo pattern forming method of a hard disk drive, comprising:
magnetically printing a reference servo pattern having different features according to zones divided along a radial direction of a disk; and
recording a final servo pattern in the disk on the basis of the reference servo pattern.

2. The servo pattern forming method according to claim 1, wherein the features of the reference servo pattern comprise at least one of a bit length and a track width of the reference servo pattern.

3. The servo pattern forming method according to claim 1, wherein the reference servo pattern has a feature that a bit length increases going from an edge to a center of the disk.

4. The servo pattern forming method according to claim 3, wherein the reference servo pattern comprises the bit lengths which are different from one another according to zones of the disk.

5. The servo pattern forming method according to claim 1, wherein the reference servo pattern has a feature that a track width increases going from an edge to a center of the disk.

6. The servo pattern forming method according to claim 5, wherein the reference servo pattern comprises the track widths which are different from one another according to zones of the disk.

7. The servo pattern forming method according to claim 1, wherein the reference servo pattern has a feature that a bit length and a track width increase as going from an edge to a center of the disk.

8. The servo pattern forming method according to claim 1, wherein the reference servo pattern is provided to have a spiral pattern.

9. The servo pattern forming method according to claim 1, wherein the magnetically printing the reference servo pattern comprises
preparing a master disk formed with a magnetic substance pattern to correspond to the reference servo pattern;
applying a first magnetic field to the disk to initially magnetize the disk;
aligning a center of the disk with a center of the master disk and making the disk and the master disk come into contact with each other; and
applying a second magnetic field opposed to the first magnetic field to the master disk.

10. The servo pattern forming method according to claim 9, wherein each of the first magnetic field and the second magnetic field is in parallel with or perpendicular to a surface of the disk.

11. The servo pattern forming method according to claim 2, wherein the features of the reference servo pattern further comprise a plurality of sub-patterns and demarcation patterns, wherein distances between the sub-patterns and demarcation patterns of a portion of the servo pattern may be adjusted to alter an amplitude of the portion of the servo pattern.

12. A method of forming a servo pattern on a hard disk, the method comprising:
forming a plurality of magnetic substance patterns on a master disk;
applying a first magnetic field to a second disk to form a second magnetic field in the hard disk;
attaching the master disk to the hard disk; and
applying a third magnetic field to the second disk to vary the direction of the second magnetic filed in the second disk to form a reference servo pattern within the hard disk; and
recording a final servo pattern in the hard disk on the basis of the reference servo pattern.

13. The method of claim 12, wherein the plurality of magnetic substance patterns include a plurality of concave and convex portions formed on the master disk.

14. The method of claim 12, wherein the plurality of magnetic substance patterns comprise:
first concave portions of a first length and second concave portions of a second length different from the first length.

15. A servo pattern forming system, comprising:
a master disk having a plurality of magnetic substance patterns formed thereon, the magnetic substance patterns comprising convex and concave portions of varying dimensions;
a hard disk to be attached and detached from the master disk; and
a magnet to be positioned close to the hard disk to apply a plurality of magnetic fields in different directions to the hard disk.

16. The system of claim 15, wherein the plurality of magnetic fields are applied with uniform magnetization.

17. The system of claim 15, wherein the plurality of magnetic substance patterns further comprise:
a reference servo pattern having an inner diameter (ID) zone and an outer diameter (OD) zone, the servo patterns in the ID zone and the OD zone having different respective dimensions and having substantially the same amplitude.

18. The system of claim 15, wherein the plurality of magnetic substance patterns further comprise:
a reference servo pattern having an inner diameter (ID) zone and an outer diameter (OD) zone, the ID zone having a plurality of sub-patterns and demarcation patterns, wherein the distances between the sub-patterns and demarcation patterns of the ID zone may be adjusted to alter the amplitude of the servo pattern of the ID zone.
